(19) United States
(12) Patent Application Publication
(10) Pub. No.: US 2012/0273126 A1
(43) Pub. Date: Nov. 1, 2012

(54) SYSTEM AND METHOD FOR LAMINATING MODULES

(75) Inventors: Roman Polo, Bern (CH); Ronald Lange, Guemligen (CH); Alessandro Chimenti, Ostermundigen (CH); Beat Strebel, Rodersdorf (CH); Juerg Zahnd, Utzenstorf (CH)

(73) Assignee: 3S SWISS SOLAR SYSTEMS AG, Lyss (CH)

(21) Appl. No.: 13/521,441

(22) PCT Filed: Jan. 19, 2010
(86) PCT No.: PCT/IB10/50240

§ 371 Date: Jul. 19, 2012

(51) Int. Cl. B32B 37/10; B29C 65/02

(52) U.S. Cl. 156/286; 156/382

(57) ABSTRACT

A system and method for laminating a module. The system comprises a membrane adapted to apply a pressure on the module to press a plurality of layers of the module together, an intermediate member adapted to prevent gases set free during a lamination process from making contact with the membrane, and a base for retaining the module, wherein the membrane and the base are capable of forming a vacuum chamber.

This application is a 35 U.S.C. 371 national-phase entry of PCT International application no. PCT/IB2010/050240 filed on Jan. 19, 2010 and published as WO2011/089473A2 on Jul. 28, 2011; the entirety of parent PCT International application no. PCT/IB2010/050240 is hereby expressly incorporated herein by reference, in its entirety and as to all its parts, for all intents and purposes, as if set forth identically in full herein.

### FIELD OF THE INVENTION

The present invention relates generally to laminating of sandwiched bodies, and, more particularly to system and methods for lamination of solar modules in a simple, cost effective, secure, and environmental friendly manner.

### BACKGROUND OF THE INVENTION

In laminating of sandwiched bodies, more particular in the lamination of lay-up of solar modules, multiple layers, including adhesive foil, are joined together under the influence of heat and pressure. During lamination, the adhesive foils undergo chemical changes. Amongst others, a polymerisation process is initiated and harmful gases including various peroxides, for example hydrogen peroxide, are set free in a chamber. Since the chamber is evacuated, the harmful gases flow off thru the conducts, but before doing so, the harmful gases come in contact with the membrane. Contact of the harmful gases with the membrane affects the membrane in a negative manner, by accelerating thermo-oxidative aging, thus shortening lifetime of the membrane.

The prior art discloses numerous different techniques for laminating sandwiched bodies, such as solar modules. Many such systems are too complex for reliable operation and are incapable of protecting the expensive membrane from the harmful gases. For example, according to the teachings of the Japanese Patent No. JP2004-306420A, a stentering frame allows gases to flow out underneath it, wherein a release sheet and the stentering frame do not prevent the gases from coming in contact with the membrane. Also, the angle of the upper side of the stentering frame and a base is relatively large, which also impairs the lifetime of the membrane.

The features of the conventional laminating systems including aforecited prior art, disclose a complex design and bulky structural indices that hinder their performance. However, no such system is available in the commercial market at the present time that is capable of preventing harmful gases from making contact with the membrane, that is, by allowing the harmful gases to be removed from the chamber without coming in contact with the membrane, in order to prolong the lifetime of the membrane.

Therefore, the present scenario is necessitating the need for a new system which is capable of overcoming disadvantages inherent lay-up laminating systems, more particularly the existing solar module laminating system, by preventing harmful gases from making contact with the membrane, that is, by allowing the harmful gases to be removed from the chamber without coming in contact with the membrane in order to prolong the lifetime of the membrane.

### SUMMARY OF THE INVENTION

In view of the foregoing disadvantages inherent in the prior arts, the general purpose of the present invention is to provide an improved combination of convenience and utility, to include the advantages of the prior art, and to overcome the drawbacks inherent in the prior art.

In one aspect of the present invention, a system for laminating a module, comprises a membrane capable of applying a pressure on the module to press a plurality of layers of the module together; an intermediate member adapted to prevent gases set free during a lamination process from making contact with the membrane; and a base for retaining the module. The membrane and the base are capable of forming a vacuum chamber.

In another aspect of the present invention, a system for laminating a module, comprises a membrane adapted to apply a pressure on the module to press a plurality of layers of the module together; a base for retaining the module; and a stentering frame extending parallel to the base. The membrane and the base are capable of forming a vacuum chamber and the stentering frame having at least a slanted face making an angle with the base in the range of 0 to 15 degrees or preferably to 10 or 5 degrees.

In another aspect, the present invention provides an improved and simplified system and method for laminating sandwiched bodies, lay-ups, and more particular for the lamination of solar module that may be mass produced inexpensively with the help of a stentering frame. The stentering frame in conjunction with the intermediate member is capable of preventing harmful gases from making contact with the membrane, that is, by allowing the harmful gases to be removed from the chamber without coming in contact with the membrane in order to prolong the lifetime of the membrane. The present invention incorporates within it simple structural indices for a simple, cost effective, secure, reliable, and environment friendly operation.

In yet another aspect, the present invention provides a stentering frame for a laminator. The stentering frame may comprise a plurality of bars connected at a plurality of corners to form a rectangle, at least a slanted face having a shallow slope adapted to compensate an elongation of a membrane; and a sealing member to provide a seal air tight against a surface. The stentering frame is capable of being pressed against the membrane and the sealing member. The bars of the stentering frame having a rectangular cross section. The stentering frame with the rectangular cross section is capable of enclosing the vacuum chamber completely. The stentering frame may be having a curved upper side. An indentation capable of being filled with a sealant may be provided on the stentering frame.

In another aspect of the present invention, a method for laminating a module, comprises the steps of: heating and pressing a lay-up of the module together, preventing gases set free during a lamination process from making contact with a membrane; lifting the membrane; and taking out the laminated module.

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

For a better understanding of the nature of the present invention, reference may be made to the detailed description taken in conjunction with the accompanying drawings in which:

FIG. 1A is a perspective of a system for laminating a module, according to an exemplary embodiment of the present invention;

FIG. 1B illustrates a lay-up of a solar module, according to an exemplary embodiment of the present invention;

FIG. 1C illustrates a laminated solar module, according to an exemplary embodiment of the present invention;

FIG. 2A illustrates a flat membrane when the cover member is in the air, according to an exemplary embodiment of the present invention;

FIG. 2B illustrates the flat membrane when the cover member is closed, according to an exemplary embodiment of the present invention;

FIG. 2C illustrates an elongated membrane when the air is removed from the vacuum chamber, according to an exemplary embodiment of the present invention;

FIG. 3 illustrates the lay-up inside the system, according to an exemplary embodiment of the present invention;

FIG. 4 illustrates a pressed membrane, according to an exemplary embodiment of the present invention;

FIG. 5 illustrates a lifted membrane after the lamination of the solar module, according to an exemplary embodiment of the present invention;

FIG. 6 illustrates the stentering frame extends to overlap by an intermediate member, according to an exemplary embodiment of the present invention;

FIG. 7 illustrates a slanted face of the stentering frame, according to an exemplary embodiment of the present invention;

FIG. 8 illustrates a flexible sheet member extending from the slanted face of the stentering frame to the module, according to an exemplary embodiment of the present invention;

FIG. 9 illustrates the flexible sheet member and the intermediate sheet member, according to an exemplary embodiment of the present invention;

FIGS. 10 and 11 illustrate an small angle 0 degree to 5 degree between an upper side of the stentering frame and a base, according to an exemplary embodiment of the present invention;

FIG. 12A to 12D illustrates the stentering frame, according to an exemplary embodiment of the present invention; and

FIG. 13 illustrates a flow graph of method for laminating the module, according to an exemplary embodiment of the present invention.

Like reference numerals refer to like parts throughout the several views of the drawings.

### DETAILED DESCRIPTION OF THE INVENTION

The exemplary embodiments described here in detail for illustrative purposes are subject to many variations and structure and design. It should be emphasized, however that the present invention is not limited to a particular system and methods for laminating sandwiched bodies, lay-up, solar module, as shown and described. Rather, the principles of the present invention may be used with a variety of lamination configurations and structural arrangements. It is understood that various omissions, substitutions of equivalents are contemplated as circumstances may suggest or render expedient, but the present invention is intended to cover the application or implementation without departing from the spirit or scope of the claims.

In the following detailed description, for purposes of explanation, numerous specific details are set forth in order to provide a thorough understanding of the present invention. It will be apparent, however, to one skilled in the art that the present invention may be practiced without these specific details.

As used herein, the terms ‘a’, ‘an’, ‘at least’ do not denote a limitation of quantity, but rather denote the presence of at least one of the referenced item, and the term ‘a plurality’ denotes the presence of more than one referenced items. The term ‘stentering frame,’ also referred to as ‘tensioning frame,’ may include any frame capable of providing tension, elongation, and extension to a membrane during a lamination process.

In an exemplary embodiment, the present invention provides an improved system and methods for laminating a module by preventing the harmful gases set free during a lamination process for making contact with a membrane. The module includes a solar module, a sandwiched body, a lay-up of a plurality of material layers, or any combination thereof. The present invention prolongs the life of the membrane and eliminates the need to change the membrane frequently. The stentering frame of the present invention may be mass produced inexpensively, and provides users an easy, efficient, secure, cost effective, environment friendly and productive way of lamination.

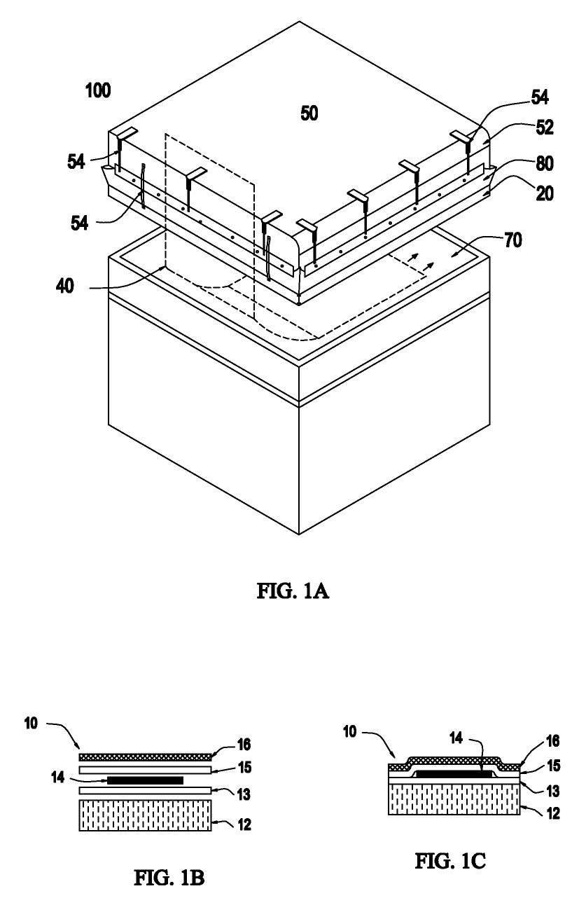

Referring to FIG. 1A which illustrates perspective view of the system 100 (also referred to as ‘laminator’), according to an exemplary embodiment of the present invention. The system 100 comprises a stentering frame 20, an intermediate member 40, a cover member 50, a base 70, and a membrane 80. The stentering frame 20 may be attached to the cover member 50 or the base 70. A plurality of couplers 54 are placed on the cover member 50 or the stentering frame 20 for holding the membrane 80. The couplers 54 may also give the membrane initial tension. The cover member 50 may have a plurality of side walls 52. The couplers 54 may be adapted to mount the stentering frame 20 and the membrane 80 to the cover member 50. The intermediate member 40 is adapted to prevent the gases from the laminating process from touching the membrane 80. The intermediate member 40 normally lies under the stentering frame 20. The intermediate member 40 may move synchronously with the modules 10. In this embodiment, the intermediate member 40 also forms a release sheet capable of preventing the membrane 80 from getting dirty. The intermediate member 40 may also form a flexible sheet member 42. The intermediate member 40 is not permeable to the gases that are not allowed to reach the membrane 80. The heating may be or come thru the membrane 80 for achieving highest degree of interconnection of the material layers and a reproducible laminating process. The base 70 may also provide the heat. The membrane 80 may be elongated in order to follow a contour of the stentering frame 20.

Referring to FIGS. 1B and FIG. 1C, wherein FIG. 1B illustrates a lay-up of unlaminated solar module 10 and FIG. 1C illustrates a laminated solar module 10, according to exemplary embodiments of the present invention. The solar module 10 may be built up out of a plurality of materials including a glass plate 12, a first adhesive foil 13, at least a solar cell 14, a second adhesive foil 15, and a back sheet 16. The back sheet 16 may be made of glass. The back sheet 16 may be placed on top of the solar cell 14. During the lamination, an interconnecting process takes place in which the solar cells 14 are encapsulated between the covering glass plate 12 and the back sheet 16 (backing of glass or foil). The back sheet may be adapted to protect the first adhesive foil 13, the second adhesive foil 15, and the solar cell 14 from getting damp, that is, the back sheet 16 protects the module 10 from weather influences, particularly moisture. The back sheet 16 may be build up from PVF and PET. The back sheet 16 may also be formed by a glass plate such that the resulted solar module 10 may be a glass-glass module.

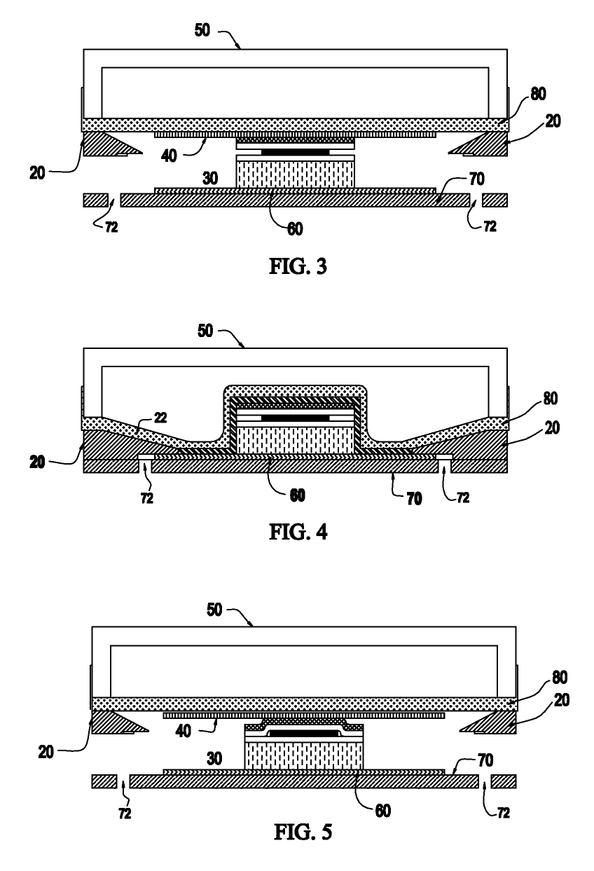

The first adhesive foil 13 and the second adhesive foil 15 have adhesive properties, such as EVA or PVB or any other thermoplastic foil such as a silicon based foil. The first adhesive foil 13 may be placed on the glass plate 12. Normally 6×8 solar cells connected in a series, are placed on the first adhesive foil 13. The lay-up includes all materials of the solar module 10, before it is laminated. Commonly, the lay-up may be placed on the base 70, the glass plate 12 laying directly on the base 70 but for a thin transport sheet 60 (shown in FIGS. 3 to 11) that may be used for pulling the lay-up into the laminator, that is, on the base 70, where the lay-up may be heated and pressed together. Once the lay-up has reached a certain temperature, for example, 90 degrees Celsius, a pressure may be applied to the lay-up, pressing all layers together.

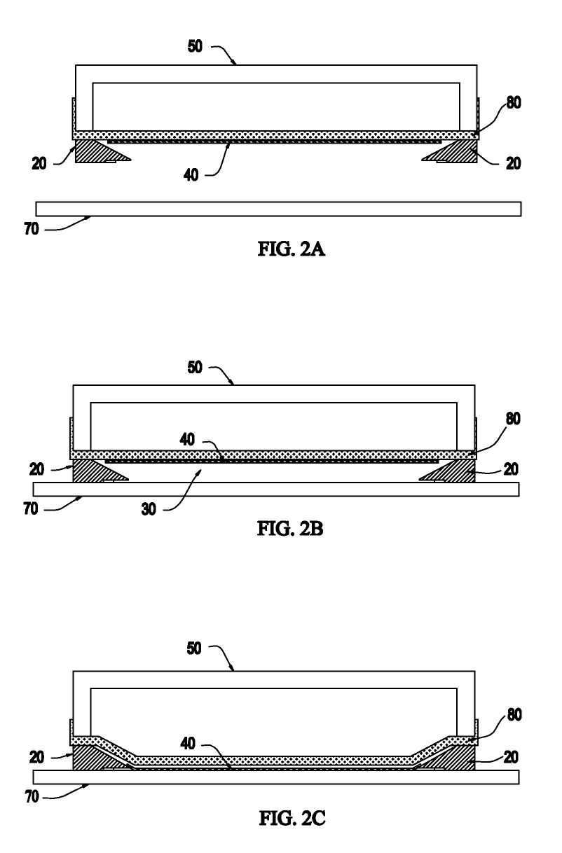

Referring now to FIGS. 2A to 2C, wherein FIGS. 2A and 2B illustrate the membrane 80 as flat when the cover member 50 is open that is, in the air and closed positions, respectively, FIG. 2C illustrates membrane 80 in elongated position when the air is removed from the vacuum chamber 30, according to exemplary embodiments of the present invention.

Referring to FIGS. 3 to 5, FIG. 3 illustrates the lay-up inside the system 100 when the cover member 50 is open, that is, in the air, according to exemplary embodiments of the present invention. The pressure may be applied by the membrane 80. The membrane 80 and the base 70 are capable of forming a vacuum chamber 30. The intermediate member 40 may be placed between the membrane 80 and the module 10, such that that materials from the module 10 that melt during the lamination process do not contaminate the membrane 80. Generally, a plurality of modules 10 are placed on a transport sheet 60 which may be adapted for moving the layups into the laminator and the modules 10 out of the laminator. In the drawings (FIGS. 3 to 11), the transport sheet 60 may move perpendicular to the plane of the drawing.

Referring to FIG. 4, according to an exemplary embodiment of the present invention, once the lay-up is inside the vacuum chamber 30, the vacuum chamber 30 may be evacuated thru a plurality of conducts 72. The atmospheric pressure on the top of the membrane 80 presses the membrane down on the lay-up, rendering an equally distributed pressure. The ends of the membrane 80 are moved down together with the stentering frame 20. Since the membrane 80 is heated up by the base 70, the membrane 80 becomes more flexible and also expands due to heat expansion. Since the membrane 80 may not fold, it would cause imprints on the back sheet 16 or rip, the membrane 80 may be tensioned by the stentering frame 20. A slanted surface 22 of the stentering frame 20 compensates the elongation of the membrane 80. The stentering frame 20 leave the conducts 72 open in order to evacuate the vacuum chamber 30.

Referring to FIG. 5, according to an exemplary embodiment of the present invention, once the lay-up has bonded, the pressures in the vacuum chamber 30 and atmospheric pressure above the membrane 80 may be equalized and the membrane 80 may be lifted. Now the laminated solar module 10 may be taken out of the laminator and the process may be repeated.

According to an exemplary embodiment of the present invention, multiple modules are laminated at the same time, forming a 2-dimensional array of maybe 2×3 modules. Modules typically are of 1200×800 millimeters (mm) in size. The dimensions in the drawings are exaggerated for clarity. Typical dimensions (thickness in mm) are: membrane 80 (3 mm), intermediate member 40 (0.25 mm), back sheet 16 (0.15 mm), adhesive foils 13 and 15 (0.6 mm), solar cell 14 (0.2 mm), glass plate 12 (3-4 mm).

According to an exemplary embodiment of the present invention, a workbench (not shown) may used to pile up the materials and may transport the material into the laminator. The laminator includes two parts: first the lay-ups enter the vacuum chamber 30 where the materials are heated and pressed together under vacuum. Then the heated and pressed materials may transported to a press where the materials are kept at a high enough temperature to allow for polymerization of the plastics. Also pressure may be applied to prevent delamination.

The membrane 80 may be adapted to apply a pressure on the module 10 to press a lay-up of the solar module 10 together. The stentering frame 20 having at least a slanted face 22 adapted to compensate an elongation of the membrane 80 during a lamination process. The intermediate member 40 may be adapted to prevent gases set free during a lamination process from making contact with the membrane 80. The couplers 54 may be mounted on the side walls 52. The base 70 is capable of retaining the solar module 10. The membrane 80, the base 70, and the side walls 52 are capable of forming a vacuum chamber 30. The lay-up of solar module 10 may be fed into the system 100 wherein the lay-up may be heated and pressed together to laminate the solar module 10.

According to an exemplary embodiment of the present invention, the vacuum chamber 30 may be formed by the cover member 50. The membrane 80 may be pulled upwards outside of the cover member 50 for tensioning. The stentering frame 20 is capable of tensioning the membrane 80 before and during the lamination. The stentering frame 20 may be held between the cover 50 and the base 70. When the lay-ups are inside the vacuum chamber 30, the cover member 50 may be lowered by a pressure and the membrane 80 may be squeezed between the stentering frame 20 and the base 70 thereby establishing an air tight sealing between the stentering frame 20 and the base 70, that is, rendering the vacuum chamber 30 air tight. At least a hydraulic cylinder may be used to lift the cover member 50. All pressure needed to press the module 10 or the lay-up may be generated by evacuating the vacuum chamber 30. The intermediate sheet may run around the complete system, thus protecting the upper part of the system from dirt.

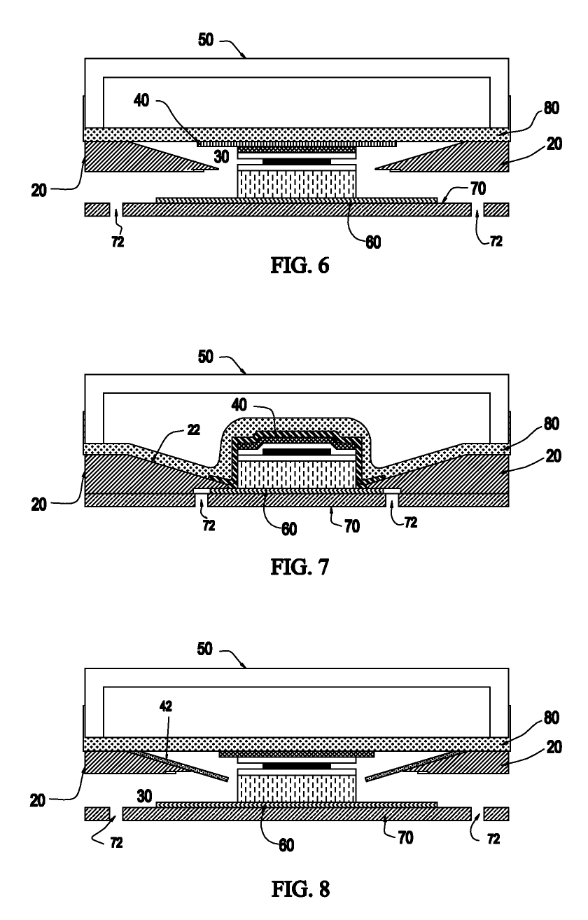

Referring to FIGS. 6 and 7, according to an exemplary embodiment of the present invention, the stentering frame 20 extends as to overlap by the intermediate sheet 40 of the lay-up, thereby protecting the membrane 80 from harmful gases set free during the lamination process. The stentering frame allows the harmful gases, e.g., hydrogen peroxide gas, to be removed from the vacuum chamber 30 without coming in contact with the membrane 80.

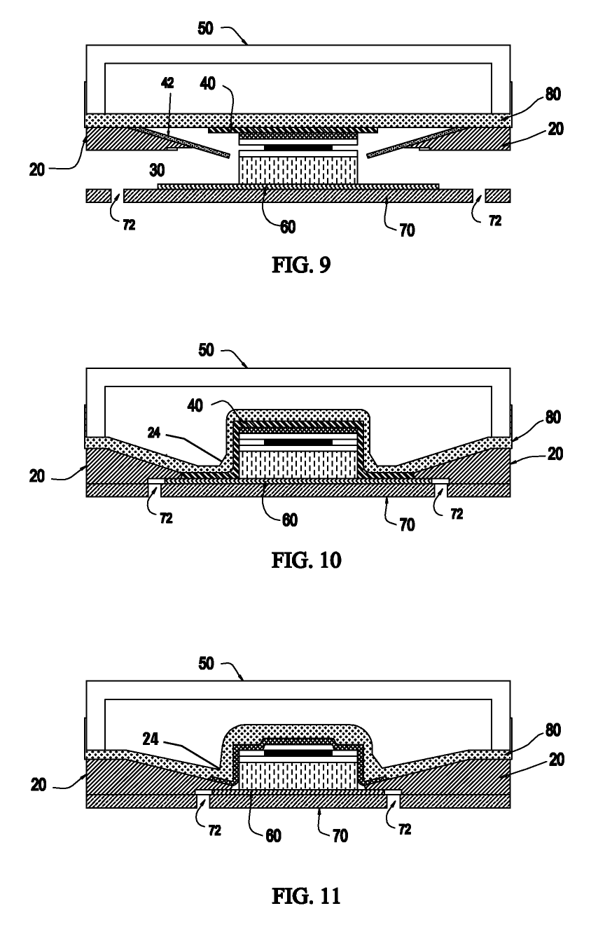

Referring to FIGS. 8 and 9, according to an exemplary embodiment of the present invention, the function of the intermediate sheet 40 may be accomplished by a flexible sheet member 42, adapted to extend from the stentering frame 20 to the module 10 or part of the module 10 and/or by the back sheet 16 extending beyond the border of the module 10.

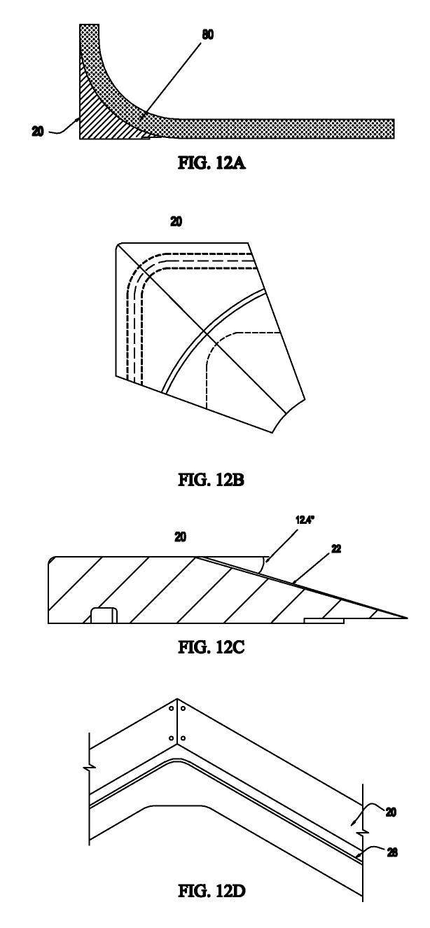

Referring to FIGS. 10 and 11, the lifetime of the membrane 80 may also be impaired by a bend 24 that the membrane 80 makes leaving the stentering frame 20. According to an exemplary embodiment of the present invention, an angle between an upper side of the stentering frame 20 and the base 70, at least near the bend 24 may be small, for example, may be smaller than 15 degrees, such as 10 degrees or may smaller than 5 degrees. Due to the exaggerated thickness of the laminated materials, the bend 24 as shown in FIG. 11, seems worse than in FIG. 10. For normal modules this is not the case.

Referring to FIGS. 12A to 12D, according to an exemplary embodiment of the present invention, the upper side of the stentering frame 20 may be curved, thus providing different angles to the base 70 over the surface of the base 70. Since the membrane 80 normally attached to the side wall 52, a stentering frame may have curved shape as shown in FIGS. 12A and 12B.

According to an exemplary embodiment of the present invention, the stentering frame 20, comprises a plurality of bars connected at a plurality of corners to form a rectangle, at least a slanted face 22 having a shallow slope adapted to compensate an elongation of the membrane 80; and a sealing member 28 to provide a seal airtight against a surface. The bars have a rectangular cross section, and the stentering frame 20 may have a curved upper side. The stentering frame 20 is capable of being pressed against the membrane 80 and the sealing member 28. The bars of the stentering frame have a rectangular cross section. The stentering frame 20 with the rectangular cross section is capable of enclosing the vacuum chamber 30 completely.

According to an exemplary embodiment of the present invention, an inside of corners of the stentering frame 20 may be formed in a plurality of shapes including a curved shape, slanted shape with shallow slope, curved shape, flat shape, triangular shape, or any combination thereof. The slanted face 22 may have a flat angle of 12.4 degrees (FIG. 12C).

According to an exemplary embodiment of the present invention, means for sealing the intermediate member 40 against the stentering frame 20 may include providing an indentation on the stentering frame 20 wherein the indentation may be capable of being filled with a sealant. The sealant may be inert against gases.

The stentering frame 20 may be provided with conducts so that air and gases may escape from the vacuum chamber 30 even if the membrane 80 and the intermediate sheet 40 are lying on top of the stentering frame 20.

According to an exemplary embodiment of the present invention, evacuation conducts 72 may be provided near base 70 or underneath the module 10 or next to the base 70 to evacuate the vacuum chamber 30. The conducts 72 may be so small, that neither the membrane 80, nor the intermediate member 40 nor the intermediate sheets 40 are pulled in, otherwise deforming them. These conducts 72 do not have to be under the stentering frame 20 and may be provided between the stentering frame 20 and the module 10 being laminated or even underneath the module 10. In the latter case the transport sheet 60 may have to be permeable to the gases that need to be removed.

According to an exemplary embodiment of the present invention, the stentering frame 20 may be rectangular so that it can enclose the complete vacuum chamber 30. The corners of the frame may be shaped in a variety of ways. The corners may simply be the cross section of the beams of the stentering frame 20 running into each other. This may result in a larger angle between the top of the inside of the corner of the stentering frame 20 and the base 70 though. Therefore, the corners may be made such that the inside of the corner may be curved so that the angle between the top of the inside of the corner of the stentering frame 20 and the base 70 may be constant, as shown in the FIG. 12B.

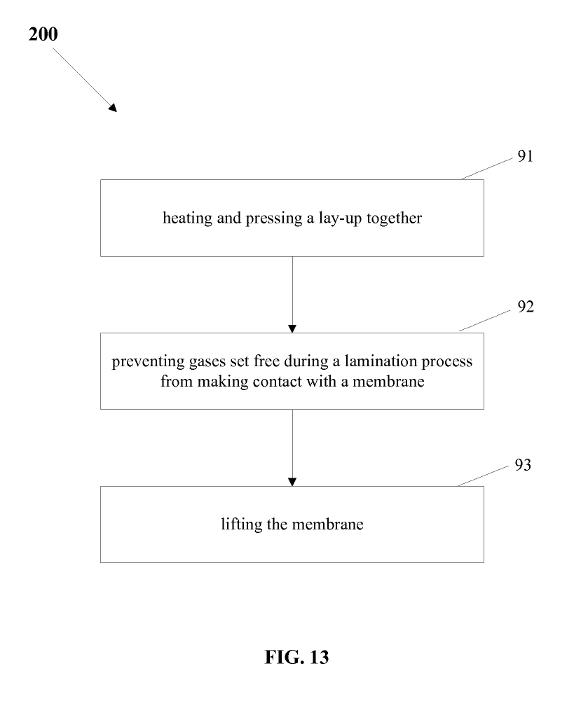

As further depicted in FIG. 13, according to an exemplary embodiment of the present invention, a method 200 for laminating a module, comprises the steps of: heating and pressing a lay-up of the module together at a step 91, preventing gases set free during a lamination process from making contact with a membrane at a step 92, lifting the membrane 80 at a step 93, and taking out a laminated module at a step 94. The intermediate member 40 may be placed on the module 10. The intermediate member 40 may be moved synchronously with the module 10.

Although particular exemplary versions of the invention have been disclosed in detail for illustrative purposes, it will be recognized to those skilled in the art that variations or modifications of the disclosed invention, including the rearrangement in the configurations of the parts, changes in sizes and dimensions, variances in terms of shape may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive, nor to limit the invention to the precise forms disclosed, and obviously many modifications and variations are possible in light of the above teachings. The embodiments were chosen and described in order to best explain the principles of the invention and its practical application, to thereby enable others skilled in the art to best utilize the invention and various embodiments with various modifications as are suited to the particular uses contemplated. It is understood that various omissions, substitutions of equivalents are contemplated, as circumstances may suggest or render expedient, but it is intended to cover their applications or implementations without departing from the spirit or scope of the appended claims of the present invention.

What is claimed is:

1-18. (canceled)

19. A module lamination system comprising:
a base configured to retain modules;
a stentering frame extending laterally relative to said base;
a membrane configured to apply pressure to press module layers together, said membrane adapted to form a vacuum chamber with said base;
a laterally-extending intermediate member configured to prevent gases liberated during lamination from contacting said membrane, said laterally-extending intermediate member having a lateral overlap relative to said stentering frame's lateral extent.

20. The module lamination system of claim 19, wherein:
said stentering frame tensions said membrane.

21. A module lamination system as claimed in claim 19, further comprising:
said stentering frame has an upper side, said upper side having an angle in the range of zero to fifteen degrees relative to said base.

22. A module lamination system as claimed in claim 19, further comprising:
said angle is in the range of five to ten degrees relative to said base.

23. A module lamination system as claimed in claim 19, further comprising:
said stentering frame has at least one corner, said corner having a curved inside.

24. A module lamination system as claimed in claim 19, further comprising:
said stentering frame has at least one corner, said corner having a slanted shape.

25. A module lamination system as claimed in claim 19, further comprising:
said stentering frame has at least one corner, said corner having a triangular shape.

26. A module lamination system as claimed in claim 19, further comprising:
said stentering frame has at least one corner, said corner having a flat shape.

27. A module lamination system as claimed in claim 19, further comprising:
said intermediate member including a flexible sheet member, said flexible sheet member laterally extending from said stentering frame to a lamination region.

28. A module lamination system as claimed in claim 19, further comprising:
conducts configured to evacuate said vacuum chamber, said conducts extending in said base.

29. A module lamination system comprising:
a base configured to retain modules;
a stentering frame extending laterally relative to said base;
a membrane configured to apply pressure to press module layers together, said membrane adapted to form a vacuum chamber with said base;
a laterally-extending intermediate member configured to prevent gases liberated during lamination from contacting said membrane, said laterally-extending intermediate member having a lateral overlap relative to said stentering frame's lateral extent;
said stentering frame has a slanted face, said slanted face making an angle in the range of zero to fifteen degrees with said base.

30. A module lamination system as claimed in claim 19, further comprising:
said angle is in the range of five to ten degrees with said base.

31. The module lamination system of claim 29, wherein:
said stentering frame tensions said membrane.

32. A module lamination system as claimed in claim 29, further comprising:
said intermediate member including a flexible sheet member, said flexible sheet member laterally extending from said stentering frame to a lamination region.

33. A module lamination system as claimed in claim 29, further comprising:
conducts configured to evacuate said vacuum chamber, said conducts extending in said base.

34. A method for laminating a module, comprising steps of:
heating and pressing a solar module lay-up;
preventing gases released by heating and pressing the solar module lay-up from making contact with a membrane;
lifting the membrane; and,
removing the solar module.

35. A method for laminating a module as claimed in claim 34, comprising step of:
moving an intermediate member synchronously with the solar module.

36. A method for laminating a module as claimed in claim 35, comprising step of:
placing the intermediate member on the module.
